(19) United States
(12) Patent Application Publication
(10) Pub. No.: US 2026/0237827 A1
(43) Pub. Date: Aug. 13, 2026

(54) HOUSING ASSEMBLY, ENERGY STORAGE DEVICE, AND ENERGY STORAGE SYSTEM

(71) Applicant: BYD COMPANY LIMITED, Shenzhen (CN)

(72) Inventors: Yunjie GAO, Shenzhen (CN); Mingxing LI, Shenzhen (CN); Guangdong XU, Shenzhen (CN)

(73) Assignee: BYD COMPANY LIMITED, Shenzhen (CN)

(21) Appl. No.: 19/632,068

(22) Filed: Mar. 27, 2026

Related U.S. Application Data
(63) Continuation of application No. PCT/CN2024/111371, filed on Aug. 12, 2024.

(30) Foreign Application Priority Data
Sep. 28, 2023 (CN) 202322677323.1

(51) Int. Cl. H01M 50/289; H01M 50/209; H01M 50/262; H01M 50/271

(52) U.S. Cl. CPC H01M 50/289; H01M 50/209; H01M 50/262; H01M 50/271

(57) ABSTRACT

A housing assembly includes a first housing member having an inner wall and an outer wall, the inner wall of the first housing member corresponding to a side of an accommodation space defined by the housing assembly, and the outer wall of the first housing member being on a side of the first housing member facing away from the accommodation space. The housing assembly includes a first reinforcing structure on the outer wall of the first housing member. Energy storage device and energy storage system counterparts are also described.

### CROSS-REFERENCE TO RELATED APPLICATIONS

The present disclosure is a continuation of International Application No. PCT/CN2024/111371, filed on August 12, 2024, which claims priority to Chinese Patent Application No. 202322677323.1, filed on September 28, 2023, and entitled "HOUSING ASSEMBLY, ENERGY STORAGE DEVICE, AND ENERGY STORAGE SYSTEM." The entire disclosures of the prior applications are hereby incorporated by reference.

### TECHNICAL FIELD

The present disclosure relates to the technical field of power supply, including a housing assembly, an energy storage device, and an energy storage system.

### BACKGROUND

Energy storage devices have attracted more and more attention due to their flexibility in applications, high reliability, high energy density, and other advantages. In a related technology, an energy storage device may include a battery cell and a housing accommodating the battery cell. The battery cell is inside the housing. In order to reduce the size or weight of an energy storage device, a thickness of the housing of energy storage device may be reduced and may be prone to deformation.

### SUMMARY

The present disclosure is related to a new technical solution for a housing assembly, an energy storage device, and an energy storage system.

According to a first aspect of the present disclosure, a housing assembly is provided. The housing assembly includes a first housing member having an inner wall and an outer wall, the inner wall of the first housing member corresponding to a side of an accommodation space defined by the housing assembly, and the outer wall of the first housing member being on a side of the first housing member facing away from the accommodation space. The housing assembly includes a first reinforcing structure on the outer wall of the first housing member.

According to a second aspect of the present disclosure, an energy storage device is provided. The energy storage device includes a functional device including a battery cell and a housing assembly defining an accommodation space that is configured to receive the functional device. The housing assembly includes a first housing member having an inner wall and an outer wall, the inner wall of the first housing member corresponding to a side of the accommodation space, and the outer wall of the first housing member being on a side of the first housing member facing away from the accommodation space. The housing assembly includes a first reinforcing structure on the outer wall of the first housing member.

According to a third aspect of the present disclosure, an energy storage system is provided. The energy storage system includes an electric device and an energy storage device configured to supply power to the electric device. The energy storage device includes a functional device including a battery cell and a housing assembly defining an accommodation space that is configured to receive the functional device. The housing assembly includes a first housing member having an inner wall and an outer wall, the inner wall of the first housing member corresponding to a side of the accommodation space, and the outer wall of the first housing member being on a side of the first housing member facing away from the accommodation space. The housing assembly includes a first reinforcing structure on the outer wall of the first housing member.

According to a fourth aspect of the present disclosure, a housing assembly is provided. The housing assembly is configured to define an accommodation space, and the housing assembly includes: a first housing member; and a first reinforcing structure, the first reinforcing structure is arranged on an outer wall of the first housing member, the outer wall of the first housing member is a surface of a side of the first housing member facing away from the accommodation space.

In an aspect, the first reinforcing structure includes: a first reinforcing rib, the first reinforcing rib extends along a first direction, and the first direction represents a length direction of the first housing member.

In an aspect, the first reinforcing structure includes: a first reinforcing rib, the first reinforcing rib extends along a second direction, and the second direction represents a width direction of the first housing member.

In an aspect, a plurality of the first reinforcing ribs are arranged on the outer wall of the first housing member, and a number of the first reinforcing ribs arranged in a middle region of the first housing member along the first direction is greater than a number of the first reinforcing ribs arranged in two side regions of the first housing member along the first direction.

In an aspect, the housing assembly further includes: a wall hanging assembly, the wall hanging assembly is arranged on the outer wall of the first housing member, and the wall hanging assembly is configured to hang the first housing member on a wall.

In an aspect, the wall hanging assembly includes: a first wall hanging piece and a second wall hanging piece, and the first reinforcing structure is arranged between the first wall hanging piece and the second wall hanging piece.

In an aspect, the housing assembly further includes: a fixing frame, the fixing frame is arranged on a side of an inner wall of the first housing member, and the fixing frame is configured to hold or carry a functional device.

In an aspect, a limiting structure is arranged at both ends of the fixing frame, and the limiting structure is configured to position the functional device.

In an aspect, the limiting structure is a limiting protrusion formed by a folded edge at both ends of the fixing frame.

In an aspect, the housing assembly further includes: a first cover and a second cover, and the first cover and the second cover are arranged spaced apart on the inner wall of the first housing member.

In an aspect, the housing assembly further includes a first side plate, the first side plate is arranged on a side of the inner wall of the first housing member, a side edge of the first side plate is connected to the inner wall of the first housing member, and the first side plate is connected to the ends on the same side of the first cover and the second cover.

In an aspect, the first side plate is arranged with a notch, and a projection of a terminal post of the functional device along the first direction is located within a projection of the notch along the first direction.

In an aspect, the housing assembly further includes a second housing member opposite to the first housing member, a baffle wall is arranged at both ends of the second housing member in the first direction, the second housing member is arranged on the first housing member, and the baffle wall is arranged in the notch, and the first direction represents the length direction of the first housing member.

In an aspect, the housing assembly further includes a second side plate and a third side plate, the second side plate and the third side plate are arranged on a side of the inner wall of the first housing member, and the second side plate and the third side plate are respectively connected to the ends on the same side of the first cover and the second cover; along the second direction, a gap is arranged between the second side plate and the third side plate, and the second direction represents the width direction of the first housing member.

In an aspect, the projection of the terminal post of the functional device along the first direction is located within a projection of the gap along the first direction.

In an aspect, the housing assembly further includes the second housing member opposite to the first housing member, the baffle wall is arranged at both ends of the second housing member in the first direction, the second housing member is arranged on the first housing member, and the baffle wall is arranged in the gap, and the first direction represents the length direction of the first housing member.

In an aspect, the housing assembly further includes a decorative cover, the decorative cover is arranged on the outer wall of the second housing member, and the outer wall of the second housing member is a surface of a side of the second housing member facing away from the battery cell.

In an aspect, a second reinforcing structure is arranged on the outer wall of the second housing member, and the second reinforcing structure is arranged between the decorative cover and the second housing member.

In an aspect, the second reinforcing structure includes a second reinforcing rib, and the second reinforcing rib extends along the second direction, and the second direction represents the width direction of the second housing member.

In an aspect, a sealing strip is arranged at an edge of the second housing member and the first housing member.

In an aspect, an insulating frame is fixed on the inner wall of the first housing member, an electric connection sheet is fixed on at least one end of the insulating frame in the first direction, a welding position is arranged on the electric connection sheet at a position corresponding to the electrode of the battery cell, and the first direction represents the length direction of the first housing member.

In an aspect, at least one of the first cover or the second cover is arranged with a handle.

According to a fifth aspect of the present disclosure, an energy storage device is provided. The energy storage device includes the housing assembly according to any one of the preceding aspects.

According to a sixth aspect of the present disclosure, an energy storage device is provided. The energy storage device includes the housing assembly, and the functional device is a battery cell.

According to a seventh aspect of the present disclosure, an energy storage device is provided. The energy storage device includes a housing assembly and a battery cell, the housing assembly is configured to define an accommodation space, and the housing assembly includes: a first housing member; and a first reinforcing structure, the first reinforcing structure is arranged on an outer wall of the first housing member, the outer wall of the first housing member is a surface of a side of the first housing member facing away from the accommodation space, and the first reinforcing structure includes a first reinforcing rib, and the first reinforcing rib extends along an arrangement direction of the battery cell.

According to an eighth aspect of the present disclosure, an energy storage system is provided. The energy storage system includes an energy storage device and an electric device, and the energy storage device is configured to supply power to the electric device, and the energy storage device is the energy storage device according to any one of the preceding aspects.

In aspects of the present disclosure, the first reinforcing structure enhances the supporting force of the first housing member, thereby reducing or preventing deformation of the first housing member caused by excessive weight of the battery cells carried by the first housing member, which affects the overall shape and the stability of the connection of the housing assembly.

In addition, the first reinforcing structure is arranged on the outer wall of the first housing member, the accommodation space is not occupied, and the capacity of the battery cells in the accommodation space is increased. Since the first reinforcing structure is arranged on the outer wall of the first housing member, the first reinforcing structure does not interfere with the functional component.

Other features and advantages of the present disclosure will become apparent from the following description of aspects with reference to the accompanying drawings.

### BRIEF DESCRIPTION OF THE DRAWINGS

The accompanying drawings, which are incorporated into and constitute a part of this disclosure, illustrate non-limiting aspects of the present disclosure and, together with the description, serve to explain the principles of the present disclosure.

FIG. 1 is an exploded view of an energy storage device according to an aspect of the present disclosure.

FIG. 2 is a schematic view of a first housing member of the energy storage device according to an aspect of the present disclosure.

FIG. 3 is an assembly schematic view of the first housing member and the battery cells of the energy storage device according to an aspect of the present disclosure.

FIG. 4 is a wiring schematic view of the energy storage device according to an aspect of the present disclosure.

FIG. 5 is an exploded view of the energy storage device according to an aspect of the present disclosure from another angle.

FIG. 6 is a schematic view of another first housing member according to an aspect of the present disclosure.

### DETAILED DESCRIPTION

Various aspects of the present disclosure will now be described with reference to the accompanying drawings. The relative arrangement of the components and steps, the numerical expressions, and values set forth in these aspects do not limit the scope of the present disclosure unless otherwise specified.

Descriptions of terms in this disclosure are provided as examples only and are not intended to limit the scope of the disclosure.

As used herein, the phrase "at least one of A, B, or C" is intended to include A alone, B alone, C alone, or any combination thereof (e.g., A and B, A and C, B and C, or A, B, and C). The phrase "one of A or B" is intended to include A alone, B alone, or both A and B.

The following description of at least one aspect is illustrative in practice and is not intended to limit the present disclosure or the use thereof.

Techniques, methods, and apparatus known to a person skilled in the relevant art may not be discussed herein. However, the techniques, methods, and apparatus should be regarded as part of the disclosure as appropriate.

In all of the examples shown and discussed herein, any specific values should be construed as illustrative, and not as limiting. Thus, other examples of the aspects may have different values.

Like reference numerals and letters refer to like items in the following drawings, and therefore, once an item is defined in one drawing, discussion of the item in the following drawings may not be necessary.

In one aspect of the present disclosure, a housing assembly 2 is provided. The housing assembly 2 is configured to define an accommodation space. The accommodation space is configured to accommodate at least part of a functional device. The functional device may be, but is not limited to, a battery cell 1, a circuit board, a heat sink, or the like. The housing assembly 2 includes a first housing member 21 and a first reinforcing structure.

The first reinforcing structure is arranged on an outer wall of the first housing member 21. The outer wall of the first housing member 21 is a surface of a side of the first housing member 21 facing away from the accommodation space.

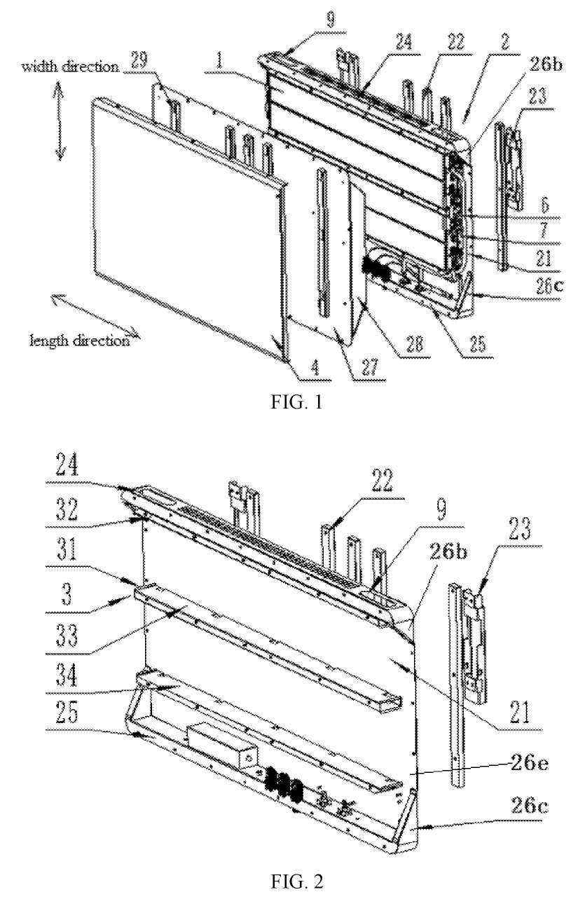

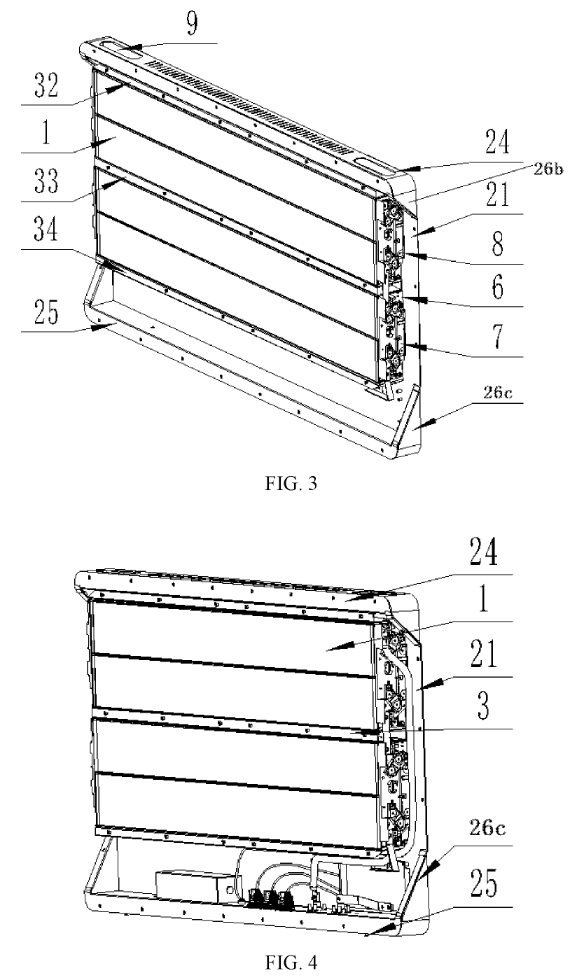

Referring to FIG. 1 to FIG. 3, the housing assembly 2 is in the shape of a cuboid. A functional device, such as a battery cell 1, is arranged inside the housing assembly 2, and the battery cell 1 is protected by the housing assembly 2. The housing assembly 2 includes a first housing member 21 and a first reinforcing structure. The battery cell 1 is arranged on the inner wall of the first housing member 21. The first reinforcing structure is fixed on the outer wall of the first housing member 21 by screws. Alternatively, the first reinforcing structure may be integrally formed with the first housing member 21. The first reinforcing structure enhances the supporting force of the first housing member 21, thereby reducing or preventing deformation of the first housing member 21 caused by an excessive weight of the battery cell 1 carried by the first housing member 21, which affects the overall shape and the stability of the connection of the housing assembly 2.

In addition, the first reinforcing structure is arranged on the outer wall of the first housing member 21, so that the first reinforcing structure does not occupy the accommodation space, and the capacity of the battery cell 1 in the accommodation space is increased. Since the first reinforcing structure is arranged on the outer wall of the first housing member 21, the first reinforcing structure does not interfere with functional devices, such as the battery cell 1.

The housing assembly 2 is not limited to the above structure in aspects of the present disclosure, and may be arranged according to various application scenarios by a person skilled in the art. For example, the housing assembly 2 is in a shape of a cylinder, an elliptical cylinder, or the like.

In an aspect, the first reinforcing structure includes a first reinforcing rib 22, the first reinforcing rib 22 extends along a first direction, and the first direction represents a length direction of the first housing member 21.

In an aspect, the first housing member 21 is in a rectangular shape. The length direction of the first housing member 21 is an extension direction of a long side. The first reinforcing rib 22 extends along the length direction of the first housing member 21. The first reinforcing rib 22 is made of metal, plastic, ceramic, or the like. The first reinforcing rib 22 is in a strip structure. The number of the first reinforcing rib 22 is one or more. For example, the first reinforcing rib 22 is fixed on the outer wall of the first housing member 21 by bolt connection, riveting, snapping, welding, or the like.

Alternatively, as shown in FIG. 1, the first reinforcing structure includes the first reinforcing rib 22, the first reinforcing rib 22 extends along a second direction, and the second direction represents a width direction of the first housing member 21.

The width direction of the first housing member 21 is an extension direction of a wide side. The size of the length direction of the first housing member 21 is greater than the size of the width direction of the first housing member 21. The first reinforcing rib 22 extends along the width direction of the first housing member 21. The material, the number, and the connection mode of the first reinforcing rib 22 are as described above.

In an aspect, as shown in FIG. 1, the first reinforcing rib 22 extends along an arrangement direction of the battery cell 1.

Inan aspect, the battery cell 1 is in a plurality. The plurality of battery cells 1 are arranged along the second direction. The extension direction of the first reinforcing rib 22 is consistent with the arrangement direction of the plurality of battery cells 1. The length direction of the battery cell 1 is perpendicular to the length direction of the first reinforcing rib 22. In this configuration, the structural strength of the first housing member 21 may be further increased.

The arrangement mode of the first reinforcing rib 22 is not limited to the above aspect, and may be selected according to various application scenarios by a person skilled in the art.

In an aspect, as shown in FIG. 1, a plurality of the first reinforcing ribs 22 are arranged on the outer wall of the first housing member 21, and a number of the first reinforcing ribs 22 arranged in a middle region of the first housing member 21 along the first direction is greater than a number of the first reinforcing ribs 22 arranged in two side regions of the first housing member 21 along the first direction.

In some aspects, the middle region of the first housing member 21 may be prone to deformation due to bearing of excessive weight. The more the first reinforcing ribs 22 are, the better the reinforcing effect on the region where the first housing member 21 is arranged. In this example, the number of the first reinforcing ribs 22 arranged in the middle region of the first housing member 21 along the first direction is greater than the number of the first reinforcing ribs 22 arranged in the two side regions of the first housing member 21 along the first direction. For example, three first reinforcing ribs 22 are arranged in the middle region, and one first reinforcing rib 22 is arranged in each of the two side regions. The structural strength of the middle region may be reinforced, and meanwhile, the uneven distribution of the first reinforcing ribs 22 may achieve the effect of weight reduction.

In an aspect, the housing assembly 2 further includes a wall hanging assembly 23, the wall hanging assembly 23 is arranged on the outer wall of the first housing member 21, and the wall hanging assembly 23 is configured to hang the first housing member 21 on a wall.

As shown in FIGS. 1 to 3, the wall hanging assembly 23 includes a wall hanging hook. The wall hanging hook is configured to cooperate with a wall hanging piece. The wall hanging hook is fixed on the outer wall of the first housing member 21 by screws. The wall hanging piece is fixed on the wall by an expansion bolt. The wall hanging hook fixedly connected to the first housing member 21 is connected to the wall hanging piece on the wall, so that the first housing member 21 is hung and fixed on the wall. The wall hanging assembly 23 and the first housing member 21 may be integrally formed or assembled together in a detachable manner.

In aspects of the present disclosure, the first reinforcing structure and the wall hanging assembly 23 are arranged on the outer wall of the first housing member 21, so that the two components share one space, space waste is reduced, and space utilization is improved.

In an aspect, the wall hanging assembly 23 includes a first wall hanging piece 231 and a second wall hanging piece 232, and the first reinforcing structure is arranged between the first wall hanging piece 231 and the second wall hanging piece 232.

For example, as shown in FIGS. 1, 2, and 5, the first wall hanging piece 231 and the second wall hanging piece 232 are respectively arranged at the two ends of the first housing member 21 in the length direction. The plurality of first reinforcing ribs 22 are arranged between the first wall hanging piece 231 and the second wall hanging piece 232. For example, when the wall hanging operation of the energy storage device is performed, the first wall hanging piece 231 and the second wall hanging piece 232 may be observed, so that the wall hanging operation of the energy storage device is facilitated.

The arrangement of the wall hanging assembly 23 and the first reinforcing ribs 22 is not limited to the above aspect, and may be arranged according to various application scenarios by a person skilled in the art.

In an aspect, the housing assembly 2 includes a fixing frame 3. The fixing frame 3 is arranged on the inner wall of the first housing member 21, and the fixing frame 3 is configured to hold or carry the battery cell 1.

Inan aspect, the fixing frame 3 is a frame structure. The number of the fixing frame 3 is one or more. The battery cell 1 is directly or indirectly mounted on the fixing frame 3. The fixing frame 3 facilitates the mounting of the battery cell 1.

In addition, the battery cell 1 is indirectly fixed on the first housing member 21 by the fixing frame 3. Since the fixing frame 3 is fixedly connected to the first housing member 21, the fixing frame 3 may also improve the bearing capacity of the first housing member 21.

In an aspect, a limiting structure is arranged at both ends of the fixing frame 3, and the limiting structure is configured to position the functional device.

For example, the limiting structure is a protrusion, a groove, or the like for positioning the battery cell 1. The limiting structure may position the battery cell 1, and reduce or prevent movement of the battery cell 1 on the fixing frame 3.

Further, the limiting structure is a limiting protrusion 31 formed by folding edges at both ends of the fixing frame 3.

For example, the fixing frame 3 includes a metal plate. Edges of both ends of the metal plate are folded to form the limiting protrusions 31. In this configuration, the limiting protrusions 31 are easier to manufacture, and the step of connecting the limiting protrusions 31 with the fixing frame 3 is saved. During installation, the battery cell 1 is fixed on the fixing frame 3 and arranged between the two limiting protrusions 31.

The height of the limiting protrusion 31 is not limited herein, and may be arranged according to various application scenarios by a person skilled in the art.

In an aspect, as shown in FIG. 2, the fixing frame 3 extends along the length direction of the first housing member 21 and is fixed on the inner wall of the first housing member 21, so that the battery cell 1 is arranged on the inner wall of the first housing member 21 in the length direction. The first reinforcing rib 22 extends along the width direction and is fixed on the outer wall of the first housing member 21. In this example, the first reinforcing rib 22 is arranged orthogonally with the fixing frame 3. Compared with the arrangement in which the extending direction of the first reinforcing rib 22 is parallel with the extending direction of the fixing frame 3, this arrangement may improve the structural strength of the first housing member 21 in different directions. The limiting protrusions 31 on the fixing frame 3 define the position of the battery cell 1, and reduce or prevent shaking of the battery cell 1 during installation or use, thereby reducing or preventing damage to the energy storage device.

In aspects of the present disclosure, the fixing frame 3 and the first reinforcing rib 22 are not limited to the orthogonal arrangement, and may be arranged to intersect at any angle. A person skilled in the art may select the intersection angle according to various application scenarios.

As shown in FIG. 2, a plurality of fixing frames 3 are arranged on the inner wall of the first housing member 21. The fixing frame 3 includes an upper bracket 32, a middle bracket 33, and a lower bracket 34. Both ends of the upper bracket 32 form downward limiting protrusions 31. Both ends of the middle bracket 33 form upward and/or downward limiting protrusions 31. Both ends of the lower bracket 34 form upward limiting protrusions 31. The limiting protrusions 31 on the three fixing frames 3 are configured to block the battery cells 1 arranged on different fixing frames 3, thereby reducing or preventing shaking of the battery cells 1 during installation and/or use, and reducing or preventing affecting the stability of the energy storage device.

The number and arrangement of the fixing frames 3 are not limited to the above aspects, and may be arranged according to various application scenarios by a person skilled in the art.

In an aspect, as shown in FIG. 1 to FIG. 5, the housing assembly 2 further includes a first cover 24 and a second cover 25, and the first cover 24 and the second cover 25 are arranged spaced apart on the inner wall of the first housing member 21.

Inan aspect, the first cover 24 and the second cover 25 are respectively arranged at the two ends of the first housing member 21 in the width direction. The first cover 24 is arranged on the top of the first housing member 21, and the second cover 25 is arranged on the bottom of the first housing member 21. The first cover 24 and the second cover 25 are fixed on the inner wall of the first housing member 21. The first cover 24 and the second cover 25 are made of metal, plastic, ceramic, wood, or the like. The first cover 24 and the second cover 25 are fixed on the inner wall of the first housing member 21 by welding, bonding, riveting, snapping, or the like to form an accommodation space between the first cover 24 and the second cover 25. The first cover 24 and the second cover 25 may improve the structural strength of the first housing member 21.

In an aspect, the first housing member 21, the first cover 24, and the second cover 25 are all made of metal material, and are integrally formed by sheet metal processing. This configuration saves the step of connecting the first housing member 21, the first cover 24, and the second cover 25, and may improve the connection strength and the structural strength of the first cover 24, the second cover 25, and the first housing member 21 compared with other connection methods.

In an aspect, as shown in FIG. 6, the housing assembly 2 further includes a first side plate 26a, and the first side plate 26a is arranged on a side of the inner wall of the first housing member 21. One side edge of the first side plate 26a is connected to the inner wall of the first housing member 21, and the first side plate 26a is connected to the ends on the same side of the first cover 24 and the second cover 25.

Inan aspect, the first side plate 26a is made of metal, plastic, ceramic, wood, or the like. The first side plate 26a is fixed on the inner wall of the first housing member 21 and/or connected to the first cover 24 and the second cover 25 by welding, bonding, riveting, snapping, or the like. For example, the first side plate 26a is arranged at the two ends of the first housing member 21 along the first direction. The first side plate 26a is connected to the first cover 24 and the second cover 25. The connection between the first housing member 21 and the first cover 24 and the second cover 25 is reinforced by the first side plate 26a, which may improve the structural strength of the whole of the first housing member 21, the first cover 24, and the second cover 25.

The arrangement of the first side plate 26a is not limited to the above aspect, and may be arranged according to various application scenarios by a person skilled in the art.

In an aspect, as shown in FIG. 6, the first side plate 26a is arranged with a notch 26d. A projection of a terminal post of the functional device along the first direction is located within a projection of the notch 26d along the first direction.

For example, the notch 26d has a trapezoidal structure with an opening at one end. The notch 26d is configured for the welding of the terminal post of the battery cell 1, and the notch 26d is arranged on the side of the housing assembly 2 to facilitate the installation and maintenance of the battery cell 1.

In an aspect, the housing assembly 2 further includes a second housing member 27 opposite to the first housing member 21, a baffle wall 28 is arranged at both ends of the second housing member 27 in the first direction, the second housing member 27 is arranged on the first housing member 21, the baffle wall 28 is arranged in the notch 26d, and the first direction represents the length direction of the first housing member 21.

The top of the second housing member 27 is connected to the first cover 24. The bottom of the second housing member 27 is connected to the second cover 25. The baffle wall 28 is embedded in the notch 26d in the trapezoidal structure. The second housing member 27, the first cover 24, the first housing member 21, the second cover 25, the baffle wall 28 and the first side plate 26a form a cuboid. For example, the whole housing assembly 2 is a cuboid.

The arrangement of the second housing member 27 and the first housing member 21 facilitates the installation of the battery cell 1. The second housing member 27 and the first housing member 21 may protect the battery cell 1.

The housing assembly 2 is not limited to the above structure in aspects of the present disclosure, and may be arranged according to various application scenarios by a person skilled in the art.

In an aspect, the housing assembly 2 further includes a second side plate 26b and a third side plate 26c, the second side plate 26b and the third side plate 26c are arranged on a side of the inner wall of the first housing member 21, and the second side plate 26b and the third side plate 26c are respectively connected to the ends on the same side of the first cover 24 and the second cover 25.

Along the second direction, a gap 26e is arranged between the second side plate 26b and the third side plate 26c, and the second direction represents the width direction of the first housing member 21.

As shown in FIG. 1 to FIG. 5, the second side plate 26b and the third side plate 26c are triangular. The second side plate 26b and the third side plate 26c form the gap 26e. Two right-angle sides of the second side plate 26b and the third side plate 26c of the first cover 24 are respectively connected to the first cover 24 and the first housing member 21, for fixing and connecting the first cover 24 and the first housing member 21. Two right-angle sides of the second side plate 26b and the third side plate 26c of the second cover 25 are respectively connected to the second cover 25 and the first housing member 21, for fixing and connecting the second cover 25 and the first housing member 21. The distance from the oblique side of the second side plate 26b and the third side plate 26c of the first cover 24 to the inner wall of the first housing member 21 gradually decreases from the end connected to the first cover 24 to the end away from the first cover 24. The distance from the oblique side of the second side plate 26b and the third side plate 26c of the second cover 25 to the inner wall of the first housing member 21 gradually decreases from the end connected to the second cover 25 to the end away from the second cover 25. The second side plate 26b and the third side plate 26c of this structure have stability, and may improve the structural strength of the first cover 24 and the first housing member 21, the second cover 25 and the first housing member 21.

Inan aspect, the second side plate 26b and the third side plate 26c are arc-shaped structures. The arc-shaped structures may also improve the structural strength of the first cover 24 and the first housing member 21, the second cover 25 and the first housing member 21.

The second side plate 26b and the third side plate 26c are not limited to the above structures in aspects of the present disclosure, and may be arranged according to various application scenarios by a person skilled in the art.

In an aspect, the projection of the terminal post of the functional device along the first direction is located within a projection of the gap 26e along the first direction.

For example, the gap 26e has a trapezoidal structure with an opening at one end. The gap 26e is configured for the welding of the terminal post of the battery cell 1, and the gap 26e is arranged on the side of the housing assembly to facilitate the installation and maintenance of the battery cell 1.

In an aspect, the housing assembly 2 further includes the second housing member 27 opposite to the first housing member 21, the baffle wall 28 is arranged at both ends of the second housing member 27 in the first direction, the second housing member 27 is arranged on the first housing member 21, the baffle wall 28 is arranged in the gap 26e, and the first direction represents the length direction of the first housing member 21.

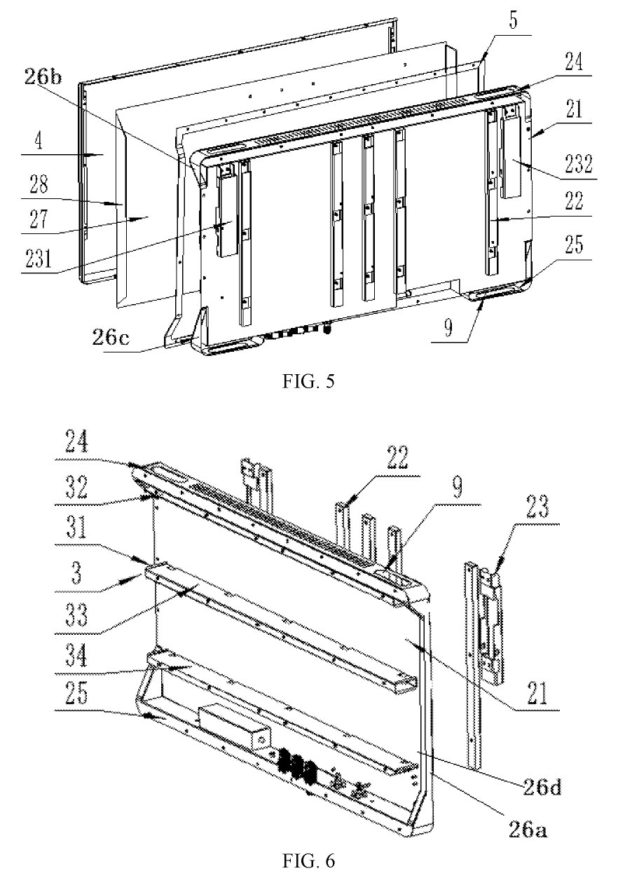

As shown in FIG. 1 and FIG. 5, the top of the second housing member 27 is connected to the first cover 24. The bottom of the second housing member 27 is connected to the second cover 25. The baffle wall 28 is embedded in the accommodation space in the trapezoidal structure. The second housing member 27, the first cover 24, the first housing member 21, the second cover 25, the baffle wall 28 and the second side plate 26b and the third side plate 26c form a cuboid. For example, the whole housing assembly 2 is a cuboid.

The arrangement of the second housing member 27 and the first housing member 21 facilitates the installation of the battery cell 1. The second housing member 27 and the first housing member 21 may protect the battery cell 1.

The housing assembly 2 is not limited to the above structure in aspects of the present disclosure, and may be arranged according to various application scenarios by a person skilled in the art.

In an aspect, the housing assembly 2 further includes a decorative cover 4, the decorative cover 4 is arranged on the outer wall of the second housing member 27, and the outer wall of the second housing member 27 is a surface of a side of the second housing member 27 facing away from the battery cell 1.

Inan aspect, the decorative cover 4 is fixed on the outer wall of the second housing member 27 by snapping, bolt connection, riveting, or the like, and the appearance of the energy storage device may be improved.

In an aspect, a second reinforcing structure is arranged on the outer wall of the second housing member 27, and the second reinforcing structure is arranged between the decorative cover 4 and the second housing member 27.

Referring to FIG. 1, the top of the second housing member 27 is connected to the first cover 24. The bottom of the second housing member 27 is connected to the second cover 25. The second housing member 27, the first cover 24, the first housing member 21, the second cover 25, the second side plate 26b, the third side plate 26c, and the baffle wall 28 are enclosed to form the housing assembly 2. The battery cell 1 is arranged inside the housing assembly 2 and is protected by the housing assembly 2. The second reinforcing structure is arranged on the outer wall of the second housing member 27 by screws, and the second reinforcing structure is arranged opposite to the battery cell 1, so that the structural strength of the second housing member 27 is enhanced by the second reinforcing structure. The second housing member 27 cooperates with the first housing member 21 to form the housing assembly 2, thereby fixing the battery cell 1 in the housing assembly 2. Since the second reinforcing structure is arranged on the outer wall of the second housing member 27, the accommodation space is prevented from being wasted, the capacity of the energy storage device is improved, and the utilization rate of the accommodation space is improved. The decorative cover 4 is fixed on the outer wall of the second housing member 27 and covers the outside of the second reinforcing structure, so that the appearance of the energy storage device may be improved.

In an aspect, the second reinforcing structure includes a second reinforcing rib 29, the second reinforcing rib 29 extends along the second direction, and the second direction represents the width direction of the second housing member 27.

Inan aspect, as shown in FIG. 1, the second reinforcing rib 29 is made of metal, plastic, ceramic, or the like. The second reinforcing rib 29 is a strip structure. The number of the second reinforcing rib 29 is one or more. For example, the second reinforcing rib 29 is fixed on the outer wall of the second housing member 27 by bolt connection, riveting, snapping, welding, or the like. The second reinforcing rib 29 extends along the second direction, and the structural strength of the second housing member 27 may be enhanced by the second reinforcing rib 29.

The second reinforcing structure is not limited to the above aspect, and may be arranged according to various application scenarios by a person skilled in the art.

In an aspect, a sealing strip 5 is arranged at the edge of the second housing member 27 and the first housing member 21.

Referring to FIG. 5, the second housing member 27 and the first housing member 21 are arranged with sealing strips 5 at the edges. For example, the first housing member 21 and the second housing member 27 are connected together by bolts, and the sealing strips 5 are pressed between the first housing member 21 and the second housing member 27. The compression amount of the sealing strips 5 is controlled to achieve the waterproof function of the housing assembly 2, so as to reduce or prevent impurities such as accumulated water and dust from entering the inside of the housing assembly 2 through the gap between the second housing member 27 and the first housing member 21 and damaging the battery cells 1. The sealing strips 5 are arranged to keep the inside of the housing assembly 2 clean, thereby prolonging the service life of the energy storage device.

In an aspect, an insulating frame 6 is fixed at at least one end of the inner wall of the first housing member 21 along the first direction, an electric connection sheet 7 is fixed on the insulating frame 6, and a welding position 8 is arranged at a position corresponding to the electrode of the battery cell 1 on the electric connection sheet 7, and the first direction represents the length direction of the first housing member 21.

As shown in FIG. 1 and FIG. 4, the insulating frame 6 is arranged at at least one end of the inner wall of the first housing member 21 in the length direction by bolt connection, snapping, riveting, or the like. The insulating frame 6 is made of plastic, rubber, silica gel, ceramic, or the like. The electric connection sheet 7 is arranged on the insulating frame 6 by bolt connection, riveting, snapping, or the like. The electric connection sheet 7 is configured to connect with the output cable or the input cable of the battery cell 1 to achieve the charging and discharging function of the battery cell 1. The insulating frame 6 is not only configured to place the electric connection sheet 7, but also configured to arrange the cable. The cable is arranged on the insulating frame 6, so that the external part of the energy storage device is simple and the appearance is improved.

For example, the total negative electrode cable of the battery cell 1 is connected to the battery management system through one electric connection sheet 7, and the total positive electrode cable of the battery cell 1 is connected to the external output port through another electric connection sheet 7, so as to achieve the charging and discharging function of the battery cell 1. One voltage sampling line is connected to each battery cell 1, and the voltage sampling line is connected to the battery management system. The battery management system is connected to a communication cable. The communication cable is connected to the external communication port, so as to realize the communication between the energy storage device and the external equipment.

The housing assembly 2 is not limited to the above structure in aspects of the present disclosure, and may be arranged according to various application scenarios by a person skilled in the art.

In an aspect, at least one of the first cover 24 or the second cover 25 is arranged with a handle 9.

Referring to FIG. 1, the first cover 24 is arranged with the handle 9 at both ends. The second cover 25 is arranged with the handle 9 at both ends. For example, the handle 9 is a strip-shaped through hole arranged on the first cover 24 and the second cover 25. When the wall-hanging operation is performed, the hand of the operator may pass through the strip-shaped through hole, so that the energy storage device may beheld, and the wall-hanging operation of the energy storage device may be performed through the handle 9.

The handle 9 is not limited to the above aspect, and may be arranged according to various application scenarios by a person skilled in the art.

According to a second aspect of the present disclosure, an energy storage device is provided. The energy storage device includes the housing assembly 2 according to any one of the above aspects.

For example, the functional device is arranged in the accommodation space and is directly or indirectly arranged on the first housing member 21.

According to a third aspect of the present disclosure, an energy storage device is provided. The energy storage device includes the housing assembly 2. The functional device is the battery cell 1.

According to a fourth aspect of the present disclosure, an energy storage device is provided. As shown in FIG. 1, the energy storage device includes the housing assembly 2 and the battery cell 1. The housing assembly 2 is configured to define an accommodation space. The housing assembly 2 includes:

the first housing member 21; and

the first reinforcing structure, and the first reinforcing structure is arranged on an outer wall of the first housing member 21. The outer wall of the first housing member 21 is a surface of a side of the first housing member 21 facing away from the accommodation space. The first reinforcing structure includes the first reinforcing rib 22, and the first reinforcing rib 22 extends along an arrangement direction of the battery cell 1.

As previously described, the first reinforcing rib 22 is arranged in this way to improve the structural strength of the housing assembly 2.

According to a fifth aspect of the present disclosure, an energy storage system is provided. The energy storage system includes the energy storage device and the electric device. The energy storage device supplies power to the electric device. The energy storage device is any one of the energy storage devices described above.

In the above aspects, differences between various examples are described. One or more features described in this disclosure may be combined without deviating from the disclosure to form different variations. For brevity, the details of these variations are not described herein.

Although some aspects of the present disclosure have been described by way of examples, a person skilled in the art should understand that the above examples are for illustration only, and are not intended to limit the scope of the present disclosure. A person skilled in the art should understand that the above aspects may be modified without departing from the scope and spirit of the present disclosure.

### Explanation of Reference Signs:

1, battery cell; 2, housing assembly; 21, first housing member; 22, first reinforcing rib; 23, wall hanging assembly; 231, first wall hanging piece; 232, second wall hanging piece; 24, first cover; 25, second cover; 26a, first side plate; 26b, second side plate; 26c, third side plate; 26d, notch; 26e, gap; 27, second housing member; 28, baffle wall; 29, second reinforcing rib; 3, fixing frame; 31, limiting protrusion; 32, upper bracket; 33, middle bracket; 34, lower bracket; 4, decorative cover; 5, sealing strip; 6, insulating frame; 7, electric connection sheet; 8, welding position; 9, handle.

What is claimed is:

1. A housing assembly, comprising:
a first housing member having an inner wall and an outer wall, the inner wall of the first housing member corresponding to a side of an accommodation space defined by the housing assembly, and the outer wall of the first housing member being on a side of the first housing member facing away from the accommodation space; and
a first reinforcing structure on the outer wall of the first housing member.

2. The housing assembly according to claim 1, wherein the first reinforcing structure comprises:
a first reinforcing rib extending along a first direction or a second direction, the first direction corresponding to a length direction of the first housing member, and the second direction corresponding to a width direction of the first housing member.

3. The housing assembly according to claim 1, wherein the first reinforcing structure comprises:
a plurality of first reinforcing ribs extending along a first direction, a number of a first subset of the first reinforcing ribs arranged in a middle region of the first housing member being greater than a number of a second subset of the first reinforcing ribs arranged in two side regions of the first housing member.

4. The housing assembly according to claim 1, further comprising:
a wall hanging assembly on the outer wall of the first housing member, the wall hanging assembly being configured to mount the first housing member on an object outside the housing assembly.

5. The housing assembly according to claim 4, wherein the wall hanging assembly comprises:
a first wall hanging piece and a second wall hanging piece, the first reinforcing structure being between the first wall hanging piece and the second wall hanging piece.

6. The housing assembly according to claim 1, further comprising:
a fixing frame on the inner wall of the first housing member, the fixing frame being configured to hold a functional device.

7. The housing assembly according to claim 6, wherein the fixing frame comprises two limiting structures at two ends of the fixing frame, the limiting structure being configured to position the functional device.

8. The housing assembly according to claim 7, wherein each one of the limiting structures includes a limiting protrusion formed by a folded edge at the respective end of the fixing frame.

9. The housing assembly according to claim 6, further comprising:
a first cover and a second cover on the inner wall of the first housing member and spaced apart from each other.

10. The housing assembly according to claim 9, further comprising:
a first side plate on a side of the inner wall of the first housing member, a side edge of the first side plate being connected to the inner wall of the first housing member, and the first side plate being connected to corresponding ends of the first cover and the second cover on the side of the inner wall.

11. The housing assembly according to claim 10, wherein the first side plate defines a notch, a projection of a terminal post of the functional device along a first direction being within a projection of the notch along the first direction.

12. The housing assembly according to claim 11, further comprising:
a second housing member opposing the first housing member, the second housing member including a baffle wall at one end of the second housing member in the first direction, and the notch being configured to receive the baffle wall.

13. The housing assembly according to claim 9, further comprising:
a second side plate and a third side plate on a side of the inner wall of the first housing member along a first direction, the second side plate and the third side plate being respectively connected to the first cover and the second cover, wherein
the second side plate and the third side plate are spaced apart along a second direction by a gap.

14. The housing assembly according to claim 13, wherein a projection of a terminal post of the functional device along the first direction is within a projection of the gap along the first direction.

15. The housing assembly according to claim 14, further comprising:
a second housing member opposing the first housing member, the second housing member including baffle wall at one end of the second housing member in the first direction, and the gap being configured to receive the baffle wall.

16. The housing assembly according to claim 1, further comprising:
a second housing member opposing the first housing member; and
a decorative cover on an outer wall of the second housing member, the outer wall of the second housing member being on a side of the second housing member facing away from the accommodation space.

17. The housing assembly according to claim 16, further comprising:
a second reinforcing structure on the outer wall of the second housing member, the second reinforcing structure being between the decorative cover and the second housing member.

18. The housing assembly according to claim 17, wherein the second reinforcing structure comprises:
a second reinforcing rib extending along a width direction of the second housing member.

19. An energy storage device, comprising:
a functional device including a battery cell; and
a housing assembly defining an accommodation space that is configured to hold the functional device, the housing assembly including:
a first housing member having an inner wall and an outer wall, the inner wall of the first housing member corresponding to a side of the accommodation space, and the outer wall of the first housing member being on a side of the first housing member facing away from the accommodation space; and
a first reinforcing structure on the outer wall of the first housing member.

20. An energy storage system, comprising:
an electric device; and
an energy storage device configured to supply power to the electric device, the energy storage device including:
a functional device including a battery cell; and
a housing assembly defining an accommodation space that is configured to receive the functional device, the housing assembly including:
a first housing member having an inner wall and an outer wall, the inner wall of the first housing member corresponding to a side of the accommodation space, and the outer wall of the first housing member being on a side of the first housing member facing away from the accommodation space; and
a first reinforcing structure on the outer wall of the first housing member.
